(19) United States
(12) Patent Application Publication
(10) Pub. No.: US 2026/0215441 A1
(43) Pub. Date: Jul. 30, 2026

(54) METHOD OF STUNNING PIGS USING GAS AND SLAUGHTERHOUSE FOR SLAUGHTERING PIGS

(71) Applicants: MAREL RED MEAT B.V., Lichtenvoorde (NL); MAREL MEAT A/S, Kastrup (DK)

(72) Inventors: Leif LYKKE, Kastrup (DK); Heinz MADSEN, Kastrup (DK); Anna Aerenlund ANDERSEN, Kastrup (DK); Johannes Martinus MEULENDIJKS, Lichtenvoorde (NL); Franciscus Theodorus Henricus Johannes VAN DER STEEN, Lichtenvoorde (NL)

(21) Appl. No.: 19/145,361

(22) PCT Filed: Jan. 18, 2024
(86) PCT No.: PCT/NL2024/050023

§ 371 Date: Jul. 2, 2025

(30) Foreign Application Priority Data
Jan. 27, 2023 (NL) 2034037

(51) Int. Cl. A22B 3/00; A22B 1/00; A22B 7/00

(52) U.S. Cl. CPC A22B 3/005; A22B 1/00; A22B 7/001

(57) ABSTRACT

A method for stunning pigs using gas, the method comprising the steps of: a) preparing the pigs to the gas-stunning procedure of the pigs; b) gas stunning the pigs in a gas-stunning chamber, after step a); wherein step a) comprises the steps of: a1) providing pigs in crates in which at least two pigs are present in each crate; a2) keeping the pigs in the crates in a relaxation chamber, wherein each crate containing pigs remains in the relaxation chamber for at least 30 minutes; a3) conveying the crates from the relaxation chamber to a conditioning chamber, in which conditioning chamber the 02 vol % is lower than 13% and higher than 6%; a4) keeping the pigs in the crates in the conditioning chamber, wherein each crate containing pigs stays in the conditioning chamber for at least 3 minutes; a5) conveying the crates from the conditioning chamber to the gas-stunning chamber.

### BACKGROUND

The invention relates to stunning pigs using gas. It is known to use gas to stun pigs. The invention is aimed at rendering gas stunning as stressless as possible for the pigs. Not only is this desirable or even required from the point of view of animal welfare, but in addition stress in pigs will often also result in meat of lower quality.

### SUMMARY

The invention is based on the view that a good preparation of the pigs to gas stunning can contribute significantly in reducing stress in pigs (immediately) prior to and during gas stunning of the pigs. In this case, the fact that pigs are usually delivered to a slaughterhouse by trucks plays a part, with the respective means of transport for the pigs, which are often only accustomed to nothing but a pigsty, is in principle a stressful experience. It is known that pigs are spurred on from the truck to a stunning installation. Not only does the fact that pigs are being urged on, which is in practice often supported by human stimulation, but also the fact that pigs have to walk inherently has the drawback that the heart rate and the stress level of the pigs will increase as a consequence. With the method according to the invention, in step A1, pigs are provided in crates in groups of at least two. The invention is based, on the one hand, on the view that pigs will suffer less stress prior to gas stunning if the pigs are placed in crates and are conveyed in those crates to a gas-stunning chamber, where the pigs will be stunned by means of gas, because it is then not necessary to spur on the pigs while they walk in the direction of the gas-stunning chamber. In addition, the pigs will suffer less stress as soon as they are in groups of at least two pigs per crate, because pigs perceive each other's company as calming. It is preferable to fill each crate with pigs having the same or at least similar properties, such as will be described in more detail below, so that the respective pigs will undergo the same treatment. In addition, by conveying the pigs in crates, human interaction with the pigs to make the pigs move to the gas-stunning chamber is rendered superfluous and the pigs do not have to exert themselves, which would result in an increase in the heart rate of the pigs. In addition, conveying pigs in crates makes tracing pigs during the stunning process or even the entire slaughtering process easier, as a result of which control of process parameters can also be simpler and what is referred to as slap marking of pigs, which is performed in many cases and which increases stress in pigs, may be rendered superfluous or at least the necessity thereof may be reduced. With the invention, the stress level of the pigs will decrease if the pigs are placed in a relaxation chamber for at least 30 minutes while being situated in crates, and if the pigs are then placed in a conditioning chamber where the O₂ vol % is lower than 13% and is higher than 6% in those same crates for at least 3 minutes. The degree of relaxation which the pigs will gradually experience during their stay in the relaxation chamber will, due to the above abovementioned O₂ vol %, change to a stupefaction of the pigs, with the conveying of the pigs in the crates from the relaxation chamber to the conditioning chamber also having a positive effect on preventing an increase in the stress level of the pigs, in particular compared to the hypothetical situation where the pigs would have to walk from the relaxation chamber to the conditioning chamber. Stupefying the pigs in the conditioning chamber may be enhanced further if, over the course of the dwell time t2, the pigs are exposed to a gas atmosphere in which the O₂ decreases, such as from a value between 8% and 13% during a first part of dwell time t2 to a value between 6% and 8% during a second part of dwell time t2.

It may be advantageous if the aforementioned dwell times t1 and/or t2 of the crates containing pigs differ from each other. This then makes it possible to adapt the dwell times t1 and/or t2 to specific characteristics of the pigs in view of the insight that the stress which is experienced by pigs prior to gas stunning of the pigs may differ per pig or group of pigs. Thus, it may for example be known that larger pigs or pigs of a specific breed take longer before they reach a stress level after they have been placed in a crate, than smaller pigs or pigs of a different breed.

In one embodiment, step A comprises the step of adjusting the dwell time t1 and/or the dwell time t2 for a crate on the basis of at least one property of the pigs in that crate. Such a property may be, for example, the sex of the pigs, the breed of the pigs, the weight of the pigs, the size of the pigs or the genotype.

In a further embodiment, step A comprises the step of observing, in step A2, A3 and/or A4, such as by means of a camera, for example of the infrared type, the or at least some of the at least one property of the pigs in a crate in step A2, A3 and/or A4, and of automatically adjusting the dwell time t1 for that crate or for an upstream crate and/or the dwell time t2 for that crate on the basis of the observations. Such a property may be, for example, the size of the pigs, the heart rate of the pigs, the heart rate variability of the pigs, the respiratory rate of the pigs, the position of the pigs (recumbent or upright) and/or the temperature of the pigs.

Step A may also comprise the steps of observing, such as by means of a camera, at least one property, such as the aforementioned properties, of the pigs in a crate in step A2, A3 and/or A4, and automatically adjusting the gas composition in the relaxation chamber and/or the gas composition in the conditioning chamber on the basis of the observations.

The dwell time t1 for two different crates may differ by at least 3 minutes from one another and/or the dwell time t2 for two different crates may differ by at least 30 seconds from one another, so that the pigs in the respective crates are subjected to a significantly different treatment prior to gas stunning.

The stress level of pigs often drops to a sufficient degree if t2 is at least 4 minutes for each crate or at least most of the crates and, more preferably, is at least 5 minutes.

On the other hand, it may also be preferred if t2 is at most 45 minutes, preferably at most 20 minutes, and more preferably at most 10 minutes for each crate or at least most of the crates. This also makes it possible to limit the volume of the conditioning chamber, thus also making it possible to limit the operational costs, such as for gas.

The stress level of pigs drops sufficiently to be able to transport the pigs onwards to the conditioning chamber in particular if t1 for each crate or at least most of the crates is at least 45 minutes.

In order to limit the volume of the relaxation chamber, but also to prevent boredom of the pigs which could still lead to an elevated stress level, it is furthermore preferred if t1 for each crate or at least most of the crates is at most 240 minutes and preferably at most 90 minutes.

It has been found that the pigs can effectively relax in the relaxation chamber if the O₂ vol % in the relaxation chamber is lower than 20% and is preferably lower than 18% and/or higher than 13% in step A2.

In order to be able to adjust the treatment of pigs before they are subjected to gas stunning accurately to their properties, the crates are conveyed through the relaxation chamber in step A2 with one crate overtaking another crate in the relaxation chamber, and/or the crates are conveyed through the conditioning chamber in step A4 with one crate overtaking another crate in the conditioning chamber. The overtaking maneuver results in the crate which overtakes another crate spending less time in the respective chamber than the other crate.

In order to limit, inter alia, the required conveying facilities and the energy consumption, it is preferred to limit the transportation of pigs, in particular in the relaxation chamber, such as for example if the crates are conveyed at most 10 minutes, preferably at most 5 minutes, inside the relaxation chamber in step A2 during dwell time t1.

As regards the conditioning chamber, an increase in the stress level of pigs can be prevented if at least most of the crates are being conveyed for most of dwell time t2, preferably for the entire dwell time t2, in step A4. Continuous transportation of pigs may also have a relaxing or even stupefying effect on the pigs. Continuous transportation of pigs in the relaxation chamber is less advantageous due to the relatively long dwell time t1 of the pigs in the relaxation chamber.

The pigs are preferably conveyed at a limited speed in order to prevent transportation from increasing stress. In this context, it may be preferable if each crate or at least most of the crates are conveyed at a conveying speed of less than 10 meters per minute in step A4.

Smooth transportation is also supported if, according to a further embodiment, in step 4, some of the crates are accelerated or decelerated during transportation, with the absolute size of the respective acceleration or deceleration being less than 0.075 meters per sec². In practice, at such relatively low accelerations, the pigs will experience the conveying procedure as being more or less free from jolts.

The pigs may be stunned efficiently if, in step B, the O₂ vol % in the gas-stunning chamber is lower than 5% and is preferably higher than 2%, and wherein, in step B, the CO₂ vol % in the gas-stunning chamber is higher than 60%, more preferably is higher than 70%, and is lower than 90%, and wherein each crate containing the pigs remains in the gas-stunning chamber for a dwell time t3 of at least 2 minutes.

The risk of an increase in stress during gas stunning may be reduced further if the pigs are exposed to a gas mixture having a CO₂ vol % lower than 80%, preferably between 60% and 75%, for at least the first 5 seconds of dwell time t3, preferably for at least the first 10 seconds of dwell time t3, and wherein, in step B, the pigs are exposed to a gas mixture having a CO₂ vol % higher than 80%, preferably between 85% and 90%, for the last half minute of dwell time t3, preferably for the last minute of dwell time t3.

In a practical embodiment, the method comprises the following consecutive steps after step B:
C1 removing the pigs stunned in step B from the crates, and
C2 conveying the stunned pigs to a stabbing station, preferably in a suspended manner,
C3 stabbing the stunned pigs at the stabbing station, so that the pigs bleed and die,
C4 slaughtering the dead pigs.

Slaughtering the pigs will result in meat of improved quality due to a reduced risk of increased stress levels of the pigs before and during gas stunning.

In a further practical embodiment, the method applies a slaughterhouse wherein
step A comprises unloading pigs from a truck at an unloading station of the slaughterhouse,
step A1 comprises moving pigs which have been unloaded from the truck during step A at a crating station of the slaughterhouse into crates, the crates being configured to accommodate at least two, preferably at most ten pigs,
step A5 comprises conveying by a conveying system of the slaughterhouse a first crate containing at least two pigs from the crating station to the gas-stunning chamber along a first conveying path and conveying by the conveying system of the slaughterhouse a second crate containing at least two other pigs along a second conveying path, the first conveying path and the second conveying path being different from each other,
the slaughterhouse further comprising the relaxation chamber, the conditioning chamber and the gas-stunning chamber.

According to a second aspect, the invention provides a slaughterhouse for slaughtering pigs, comprising
an unloading station for unloading pigs from a truck,
a crating station with crates for moving pigs which have been unloaded from the trucks into crates, the crates being configured to accommodate at least two, preferably at most ten pigs,
a relaxation chamber,
a conditioning chamber,
a gas-stunning chamber,
a conveying system for conveying crates containing pigs from the crating station to the gas-stunning chamber via the relaxation chamber and the conditioning chamber, successively,
wherein the conveying system is configured for conveying the crates from the crating station to the gas-stunning chamber along various conveying paths.

The advantages which may be achieved by such a slaughterhouse, in particular with regard to the possibility of subjecting the pigs to different treatments before gas stunning the pigs in order thus to relax the pigs as efficiently as possible and with an increased level of certainty have already been explained above by means of the description of the method according to the invention.

The aforementioned various treatments may be performed efficiently, inter alia, if the conveying system has different conveying paths in the relaxation chamber and/or in the gas-stunning chamber. The selection of a specific conveying path may also be an actual selection of the dwell times of the pigs in the relaxation chamber and/or in the conditioning chamber.

The different conveying paths may be produced in a suitable manner if the conveying system in the relaxation chamber and/or in the conditioning chamber comprises a supply conveying path section, two or more shunting path sections which extend parallel to each other, and a discharge conveying path section, which shunting path sections each connect to the supply conveying path section at an upstream end and which each connect to the discharge conveying path section at a downstream end.

Alternatively, or in combination, the conveying system in the conditioning chamber and/or in the relaxation chamber may comprise a main conveying path section and at least one buffer conveying path section which branches off from the main conveying path section.

Due to the above-described advantages, in one embodiment of the slaughterhouse, the conditioning chamber has a gas atmosphere-adjusting device for producing a gas atmosphere in the conditioning chamber with an O₂ vol % which is lower than 13% and preferably higher than 6%, and/or the relaxation chamber has a gas atmosphere-adjusting device for producing a gas atmosphere in the relaxation chamber with an O₂ vol % which is lower than 20% and preferably lower than 18% and/or higher than 13%.

Also due to the above-described advantages, in one embodiment, the slaughterhouse has a control unit which is configured to adjust the dwell time t1 for which a crate is present in the relaxation chamber and/or the dwell time t2 for which a crate is present in the conditioning chamber on the basis of at least one property of the pigs, and/or the slaughterhouse comprises observation means for observing at least one property of pigs in a crate while the crate is situated in the relaxation chamber and/or in the conditioning chamber.

For further processing of the pigs after they have been stunned, the slaughterhouse, in a further embodiment, also comprises an unloading station for removing pigs which have been stunned in the gas-stunning chamber from the crates,
a stabbing station for stabbing the stunned pigs, so that the stunned pigs bleed and die,
a slaughter device for slaughtering the dead pigs,
a further conveying system for conveying the pigs from the unloading station to the stabbing station, and preferably onwards towards the slaughter device.

The further conveying system may in this case advantageously be configured to convey the pigs in a suspended manner.

The slaughterhouse is preferably configured to carry out the method for stunning pigs by means of gas according to the invention, as has or has not been explained above by means of optional embodiments thereof.

### BRIEF DESCRIPTION OF THE DRAWINGS

FIG. 1 diagrammatically shows a part of a slaughterhouse according to the invention which is particularly relevant to the invention, which slaughterhouse is configured to carry out the method according to the invention.

### DESCRIPTION OF EMBODIMENTS

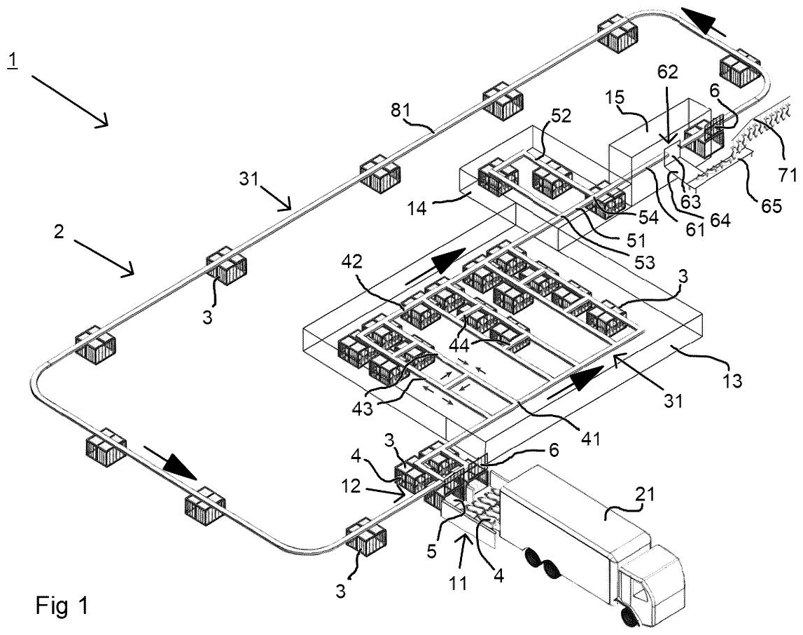

Slaughterhouse 1 according to FIG. 1 comprises a conveying system 2 for conveying crates 3. Each crate 3 comprises an opening 5 via which pigs 4 can enter the crate. The opening 5 is closeable by means of a wall section 6 which is displaceable between an open and a closed position, in this exemplary embodiment more specifically slidable in an upward and downward direction. Alternatively, the crates could also comprise an opening which is closeable in another way, for example by means of one or two swinging doors or by means of one or two doors which are horizontally slidable to and fro. In this case, the conveying system 2 is able to convey the crates 3 independently from each other, so that for example conveying speeds of crates 3 may differ from each other.

Slaughterhouse 1 further comprises an unloading station 11 for unloading pigs 4 from a truck 21, and a crating station 12 adjoining the unloading station for moving pigs which have been unloaded from the trucks into crates 3, so that at least two and at most ten pigs 4, such as for example five pigs, are accommodated per crate 3.

Slaughterhouse 1 further comprises a relaxation chamber 13, a conditioning chamber 14 and a gas-stunning chamber 15. The chambers 13, 14 and 15 are at least substantially sealed from the environment in an airtight manner, so that an atmosphere can be produced in each of these chambers which differs from the atmosphere outside the respective chambers. To this end, each of the chambers 13, 14 and 15 comprises gas atmosphere-adjusting devices (not shown in more detail) by means of which at least the O₂ vol % in the respective chamber can be adjusted and, for chamber 15, also the CO₂ vol % and/or any other gasses which may be used to stun the pigs 4, such as argon (Ar) and helium (He), optionally mixed with one another or with CO₂, can be adjusted.

The chambers 13, 14, 15 all adjoin each other at the passages where the chambers 13, 14, 15 are joined to each other. The respective passages may also be designed as locks in order to ensure that the atmosphere in the chambers is not affected by the atmosphere in a neighboring chamber or in the free space outside the chambers 13, 14, 15.

In the present exemplary embodiment, conveying system 2 comprises a rail guide system 31 which is configured to be able to convey the crates 3 from the crating station 12 to the gas-stunning chamber 15 along different conveying paths in a manner suspended from the rail guide system 31. Alternatively, the conveying system 2 could also be of a different type, such as for example a belt conveying system in which the crates 3 rest on driven belts during conveying.

Inside the relaxation chamber 13, the rail guide system 31 comprises a supply guide 41, a discharge guide 42, and three parallel pairs of two shunt guides 43 which extend perpendicularly to the supply guide 41 and the discharge guide 42 and adjoin the latter with their ends. Between the two shunt guides 43 forming a pair, buffer guides 44 extend at approximately one third and two thirds from their respective lengths which connect the respective two shunt guides 43 to each other. Both the shunt guides 43 and the buffer guides 44 are configured so that crates 3 can be conveyed along them in two opposite directions. In this way, the total of six shunt guides 43 and the buffer guides 44 provide the possibility of conveying the crates through the relaxation chamber 41 along different conveying paths. In this case, the crates 3 are able to move past each other. The different conveying paths thus make it possible for the dwell times t1 for crates 3, for the duration of which the crates 3, and thus also the pigs 4, remain in these crates 3 in relaxation chamber 13, to differ from each other.

Inside the conditioning chamber 14, the rail guide system 31 comprises a main passage guide 51 and a loop-shaped bypass guide 52. At the passage between the relaxation chamber 13 and the conditioning chamber 14, the main passage guide adjoins the discharge guide 42 and extends in a straight line as a continuation thereof. Inside the conditioning chamber 14, the bypass guide 52 adjoins, by means of its ends, the main passage guide 51 at a first position 53 and at a second position 54 which is situated downstream with respect to the first position 53. Thus, there are two different conveying paths inside the conditioning chamber, namely a short one which only runs via the main passage guide and a longer one which runs via the bypass guide 52. In this case, the crates 3 are able to move past one another inside the conditioning chamber. The respective different conveying paths thus offer the possibility for the dwell times t2 of crates 3, which the crates 3, and thus also the pigs 4 in these crates 3, spend in the conditioning chamber, to differ from each other. In an alternative embodiment, the loop-shaped guide 52 could, by contrast, form part of the main passage guide and the part of the guides between the positions 53 and 54 could form a buffer guide.

In a further alternative embodiment, the conveying system inside the conditioning chamber 14 could be configured to have a number of shunt guides similar to shunt guides 43 inside the relaxation chamber instead of the bypass guide 52. In a further alternative embodiment, the conveying system inside the conditioning chamber 14, instead of being provided with the bypass guide 52, could be configured to have one or more juxtaposed buffer positions which are provided along the main passage guide 51 and which each offer space for temporarily buffering at least one crate 3. A crate 3 can thus be conveyed laterally from the main passage guide 51 to such a buffer position and be conveyed back from that buffer position to the main passage guide 51 after some time. During this certain period of time, another crate 3 can move past the buffered crate 3 inside the conditioning chamber and the dwell times t2 of the respective crates 3 inside the conditioning chamber 14 will differ from each other. The optional conveying of the crates 3 to and from one of the buffer positions entails that, in such alternative embodiments, the number of conveying paths inside the conditioning chamber 14 equals the number of buffer positions plus one.

Incidentally, it is also possible to use buffer positions inside the relaxation chamber 13 instead of or in addition to the layout using the shunt guides 43. Such buffer positions could also be positioned one above the other, for example when the crates containing pigs are temporarily stored, during dwell time t1, in storage positions which are situated one above the other and next to one another in one or more storage racks. The conveying system may comprise a movable traveling lift to this end.

Inside the gas-stunning chamber 15, the rail guide system 31 comprises a rail guide 61 which extends horizontally and in a straight line. At an upstream end of the rail guide 61, rail guide 61 adjoins the downstream end of the main passage guide 51 at the transition between the conditioning chamber 14 and the gas-stunning chamber 15.

In alternative embodiments, it is also possible for the conveying system 2 to be configured to convey the crates 3 vertically up and down through a pit containing a stupefying gas or for the conveying system 2 to be configured to convey crates 3 through a sunken chamber in which the crates 3 enter the sunken chamber via a slightly downwardly sloping conveying path section, for example at an angle of 15 degrees to a horizontal plane, and exit again via a slightly upwardly sloping conveying path section.

The gas-stunning chamber 15 also comprises an unloading station 62 for removing the pigs which have been stunned in the gas-stunning chamber from the crates. At the location of the unloading station 62, the rail guide 61 is interrupted in order to allow a crate 3 to tilt laterally. At the location of the unloading station, an opening 63 is provided in a longitudinal wall of the gas-stunning chamber 15 onto which a chute 64 is joined. The bottom end of the chute is in turn adjoined by a table 65. Above the table, a (partly shown) conveying system 71 extends comprising hooks from which stunned pigs 4 can be suspended by their hind legs.

The slaughterhouse 1 further comprises a stabbing station (not shown in more detail) which is known to those skilled in the art for stabbing the carotid vein of stunned pigs 4, so that the stunned pigs 4 bleed and die. As part of an endless conveying path, the conveying system 71 is configured to convey the stunned pigs 4 from the table 65 to the stabbing station and then onwards to a slaughter device (not shown in more detail) which is known per se to those skilled in the art for slaughtering the dead pigs 4.

The rail guide system 31 further comprises a return guide 81 by means of which the emptied crates 3 can be conveyed back to the unloading station 11. In this case, the crates 3 may be passed via a cleaning station (not shown in more detail) for cleaning the emptied crates 3. Furthermore, the conveying system 2 may be provided with a store, preferably in the area of the return guide 81, for temporarily storing crates 3 which are no longer required for processing pigs 4 at a certain point in time.

In operation, when using the slaughterhouse 1, pigs 4 to be slaughtered are unloaded from truck 21 at the location of unloading station 11. Immediately after unloading, at the location of the loading station 12 the pigs 4 are moved into a crate 3 via the open opening 5 thereof, in which case it is preferable for pigs 4 of similar proportions, insofar as these are known at that point in time, to be moved into the same crate 3 as much as possible. As soon as a desired number of pigs 4 is in a crate 3, the latter is closed by sliding the wall section 6 thereof down. Subsequently, the respective crate 3 containing a group of pigs 4 is conveyed to the relaxation chamber 13 by means of the conveying system 2 and the freed-up position at the location of the loading station 12 is filled by an empty open crate 3, so that the next pigs can be moved into the respective crate.

An atmosphere is produced in the relaxation chamber 13, in which the O₂ vol % has been reduced with respect to the O₂ vol % in the free atmosphere directly outside the relaxation chamber 13. The O₂ vol % in the relaxation chamber is preferably lower than 20% and more preferably lower than 18% and/or higher than 13%. In practice, a percentage between 14% and 16% will in many cases be found to be optimal. Said reduced oxygen percentages have the effect that the pigs 4 in the crates 3 become accustomed to a reduced oxygen percentage and become relaxed and less active more quickly in the process. The lower limits for the oxygen percentage in the relaxation chamber mentioned are important in order to prevent the pigs 4 from starting to feel uncomfortable, which would actually increase the stress level of the pigs 4.

In order to ensure that the aforementioned acclimatization and relaxation of the pigs 4 occurs to a desired degree, the dwell time t1 of the crates 3, and thus of the pigs 4, in the relaxation chamber 13 is at least 30 minutes and preferably not more than 240 minutes. Time periods exceeding the latter increase the risk of the pigs 4 becoming restless again due to having to wait. In practice, a dwell time t1 of at least 45 minutes and at most 90 minutes will in many cases be found to be optimal. In this case, the dwell time t1 per crate 3 may differ due to the fact that the crates 3 can follow different conveying paths inside the relaxation chamber 13. The dwell times t1 may in this case be adapted to properties of the pigs 4 in the crates 3. Such properties may be, for example, the size or the weight of the pigs 4. Thus, relatively large or heavy pigs 4 will benefit from a longer dwell time t1 than relatively small or lightweight pigs 4. Another relevant property may be the breed of the pigs 4. It has been found that pigs 4 of the Duroc breed are relatively susceptible to stress, as a result of which such pigs benefit from a longer dwell time t1. It may also be useful to make a distinction within a breed, for example on the basis of genotypes. Male pigs, in particular when they have not been castrated, have also been found to be more susceptible to stress than female pigs and may therefore also benefit from a longer dwell time t1. In addition, the time which has passed since the pigs 4 were last fed may be a relevant property.

The aforementioned properties of pigs on the basis of which an optimum or desired dwell time of the pigs in relaxation chamber 13 can be determined, may also be determined, preferably automatically, by means of observation means, such as cameras. By means of cameras or the like, it is possible, for example, to determine if a pig 4 in a crate 3 is recumbent or upright in a crate 3, with a recumbent pig 4 being an additional indication that the pig 4 has become sufficiently relaxed to be conveyed to the conditioning chamber. Other properties of pigs 4 which may be observed by means of observation are, for example, the number of heartbeats per minute, the heart rate variation or the respiratory rate, which properties are also relevant in determining an optimum dwell time t1. The control unit of the slaughterhouse 1 may in this case control the conveying system 2 in such a way that the actual dwell time t1 of pigs in a crate corresponds to the desired dwell time for the respective pigs 4 in relaxation chamber 13. As a result thereof, crates 3 may leave the relaxation chamber 13 in a different order than when they entered this relaxation chamber 13.

The properties of pigs 4, whether they have been observed by observation means or not, may also be used to adjust the gas composition of the atmosphere in the relaxation chamber 13, and then in particular the oxygen percentage in said atmosphere. In general, it is the case that the more susceptible pigs are to stress, the more useful it may be to select an oxygen percentage which is lower than is the case with pigs which are less sensitive to stress. There may also be exceptions to this general rule, for example if the condition of the lungs of a pig is suboptimal. In that case, it is usually preferable to give precedence to dwell times over oxygen percentage as the determining factor.

It is preferable for the crates 3, and therefore also the pigs 4, in the relaxation chamber 13 to be stationary as much as possible as this will benefit relaxation. In case they have to be conveyed by means of the conveying system 2, the conveying speed should preferably not exceed 10 meters per minute. Conveying is preferably carried out in such a way as to avoid jolts as much as possible, since jolts may upset the state of relaxation of the pigs 4. Therefore, the absolute size of an acceleration or deceleration during transportation is preferably less than 0.075 meters per sec², for example 0.05 meters per sec².

As soon as the pigs 4 in relaxation chamber 13 have become sufficiently relaxed and have become accustomed to the reduced oxygen percentage in relaxation chamber 13, the respective crates 3 are conveyed onwards through conveying system 2 to the conditioning chamber 14. The dwell time t2 of each crate 3 in the conditioning chamber 14 is at least 3 minutes. In the conditioning chamber 14, the oxygen percentage is reduced further, namely to an O₂ vol % which is between 6% and 13%. The transportation of the crates 3 inside the conditioning chamber 14 may in this case proceed at a continuous speed which is preferably lower than 10 meters per minute. The aforementioned dwell time t2 and the aforementioned oxygen percentages in the relaxation chamber cause the pigs 4 which have already become relaxed in the relaxation chamber 13 to be stupefied and they will consequently become increasingly unaware of their environment. The optimum dwell time t2 of pigs 4, which may not only be adjusted by selecting a suitable conveying path inside the conditioning chamber 14, but also by increasing or decreasing the speed of transportation, may also be determined, just as the dwell time t1 in the relaxation chamber 13, on the basis of properties of the pigs 4 in the conditioning chamber 14 which may or may not have been observed by observation means in relaxation chamber 13 or in conditioning chamber 14. These properties may also be used in order to adjust the gas composition, more specifically the oxygen percentage thereof, in the conditioning chamber 14 based on these properties. The dwell time t2 for each crate 3 is preferably at most 45 minutes, preferably at most 20 minutes and more preferably at most 10 minutes.

Any properties observed in the conditioning chamber 14 may also be used to determine an optimum dwell time in relaxation chamber 13, for example if it is found that pigs 4 from a specific group of pigs, some of which are still in the relaxation chamber 13 and some of which are already in the conditioning chamber 14, behave differently than expected, which may affect the optimum dwell time for pigs of the group which are still in the relaxation chamber 13 or for the desired gas composition, more specifically the oxygen percentage thereof, in the relaxation chamber 13. Subsequently, the control unit of the slaughterhouse 1 may adjust the gas composition and the respective dwell times in accordance with the determined optimum dwell time and the desired gas composition.

Due to the aforementioned dwell time t2 and oxygen percentages of the atmosphere in the conditioning chamber 14, the pigs 4 in the conditioning chamber 14 are stupefied to such a degree that they can be conveyed to the gas-stunning chamber 15 to be subjected to gas stunning. As a result of the above-described preparation of the pigs to the gas-stunning procedure, the pigs 4 react significantly less strongly to exposure to the stupefying gas in the gas-stunning chamber compared to the prior art. In this case, the pigs 4 will lose consciousness without showing strong reactions during the gas-stunning procedure. This is beneficial from the point of view of animal welfare and with regard to the quality of the meat.

Incidentally, it is also possible for the pigs in the conditioning chamber 14 to be exposed to a gas atmosphere in which the O₂ vol % decreases within the aforementioned bandwidths, for example from 10% to 6%, during the dwell time t2. As a result thereof, the oxygen percentage changes even more gradually, as a result of which the risk of an increase in stress in the pigs 4 is reduced further.

It is likewise possible to use other gases in the conditioning chamber 14, such as for example, helium. The helium may, on the one hand, be used to force oxygen out of the conditioning chamber 14 in order thus to decrease the O₂ vol %. On the other hand, the helium may have an additional relaxing or stupefying effect on the pigs 4.

In this case, gas stunning the pigs 4 may be performed by exposing the pigs inside the gas-stunning chamber 15 for a dwell time t3 of at least 2 minutes and preferably of at most 4 minutes to an atmosphere in which the O₂ vol % is lower than 5% and preferably higher than 2%, and in which the CO₂ vol % is higher than 60% and lower than 90%. In this case, it may be advantageous if the pigs 4, during dwell time t3, are first exposed, for example during at least the first 5 seconds or during at least the first 10 seconds of dwell time t3, to an atmosphere in which the CO₂ vol % is lower than 80% or lower than 75%, and the pigs 4 are then, for example during at least the last half minute or during at least the last minute of dwell time t3, exposed to an atmosphere in which the CO₂ vol % is higher than 80%, such as for example a percentage of between 85% and 90%. By starting off with a CO₂ percentage lower than 80% during dwell time t3, the risk of still increasing the stress level of the pigs 4 is reduced. Alternatively, it is also possible for the pigs 4 inside gas-stunning chamber 15 to be exposed to an atmosphere in which the CO₂ vol % is higher than 80% for the entire dwell time t3.

In an alternative embodiment, it is also possible for gas stunning to be performed using other gases than CO₂, such as helium and/or argon. Such gases may also be mixed with CO₂.

After dwell time t3, opening 5 of a crate 3 is opened by sliding wall section 6 up and the crate 3 is tilted at the location of unloading station 62, so that the pigs slide from the crate 3 onto table 65 via opening 63 and chute 64. From the table 65, the pigs are suspended from hooks of the hanging conveying system 71 by their hind legs in order to be conveyed by the conveying system 71 to successively the stabbing station and the slaughter installation of slaughterhouse 1 in order to be slaughtered.

1.-31. (canceled)

32. A method of stunning pigs using gas, the method comprising the following steps:
(A) preparing the pigs for the gas-stunning procedure of the pigs;
(B) gas stunning the pigs in a gas-stunning chamber, after step A;
wherein step A comprises the steps of:
(A1) providing pigs in crates in which at least two pigs and at most ten pigs are present in each crate;
(A2) keeping the pigs in the crates in a relaxation chamber, wherein each crate containing pigs remains in the relaxation chamber for a dwell time t1, wherein t1 is at least 30 minutes;
(A3) conveying the crates containing the at least two pigs from the relaxation chamber to a conditioning chamber, in which conditioning chamber the O2 vol % is lower than 13% and higher than 6%;
(A4) keeping the pigs in the crates in the conditioning chamber, wherein each crate containing pigs stays in the conditioning chamber for a dwell time t2, wherein t2 is at least 3 minutes;
(A5) conveying the crates containing the at least two pigs from the conditioning chamber to the gas-stunning chamber.

33. The method according to claim 32, wherein the dwell time t1 for two different crates differs from each other and/or wherein the dwell time t2 for two different crates differs from each other.

34. The method according to claim 32, wherein step A comprises the step of adjusting the dwell time t1 and/or the dwell time t2 for that crate on the basis of at least one property of pigs in a crate.

35. The method according to claim 34, wherein step A comprises the step of observing, with a camera, at least one property of the pigs in a crate in steps A2, A3 and/or A4, and automatically adjusting the dwell time t1 for that crate or for an upstream crate and/or the dwell time t2 for that crate on the basis of the observations.

36. The method according to claim 32, wherein step A comprises the steps of observing, with a camera, at least one property of the pigs in a crate in step A2, A3 and/or A4, and of automatically adjusting the gas composition in the relaxation chamber and/or the gas composition in the conditioning chamber on the basis of the observations.

37. The method according to claim 32, wherein the dwell time t1 for two different crates differs at least 3 minutes from each other and/or wherein the dwell time t2 for two different crates differ at least 30 seconds from each other.

38. The method according to claim 32, wherein t2 for each crate or at least for most of the crates is at least 4 minutes.

39. The method according to claim 32, wherein t2 for each crate or at least most of the crates is at most 45 minutes.

40. The method according to claim 32, wherein t1 for each crate or at least most of the crates is at least 45 minutes.

41. The method according to claim 32, wherein t1 for each crate or at least most of the crates is at most 240 minutes.

42. The method according to claim 32, wherein, in step A2, the O2 vol % in the relaxation chamber is lower than 20% and/or higher than 13%.

43. The method according to claim 32, wherein the crates are conveyed through the relaxation chamber in step A2, and
wherein a crate overtakes another crate in the relaxation chamber, and/or
wherein the crates are conveyed through the conditioning chamber in step A4, and
wherein a crate overtakes another crate in the conditioning chamber.

44. The method according to claim 32, wherein, in step A2, the crates are conveyed inside the relaxation chamber during dwell time t1 for at most 10 minutes.

45. The method according to claim 32, wherein, in step A4, at least the majority of the crates are conveyed during the majority of dwell time t2.

46. The method according to claim 32, wherein, in step A4, each crate or at least most of the crates are conveyed at a conveying speed of less than 10 meters per minute.

47. The method according to claim 32, wherein, in step A4, some of the crates are accelerated or decelerated during transportation, with the absolute size of the respective acceleration or deceleration being less than 0.075 meters per sec².

48. The method according to claim 32, wherein, in step B, the O2 vol % in the gas-stunning chamber is lower than 5% and higher than 2%, and
wherein, in step B, the CO2 vol % in the gas-stunning chamber is higher than 60% and lower than 90%, and
wherein each crate containing the pigs remains in the gas-stunning chamber for a dwell time t3 of at least 2 minutes.

49. The method according to claim 48, wherein the pigs are exposed to a gas mixture having a CO2 vol % lower than 80%, for at least the first 5 seconds of dwell time t3; and
wherein, in step B, the pigs are exposed to a gas mixture having a CO2 vol % higher than 80%, or between 85% and 90% during the last half minute of dwell time t3, or the last minute of dwell time t3.

50. The method according to claim 32, wherein the method comprises the following consecutive steps after step (B):
(C1) removing the pigs stunned in step B from the crates; and
(C2) conveying the stunned pigs to a stabbing station;
(C3) stabbing the stunned pigs at the stabbing station, so that the pigs bleed and die;
C4 slaughtering the dead pigs.
